(19) United States
(12) Patent Application Publication
(10) Pub. No.: US 2019/0088977 A1
(43) Pub. Date: Mar. 21, 2019

(54) METHOD FOR MANUFACTURING SECONDARY BATTERY

(71) Applicant: SANYO Electric Co., Ltd., Osaka (JP)

(72) Inventors: Ryoichi Wakimoto, Hyogo (JP); Naoya Tada, Hyogo (JP)

(73) Assignee: SANYO Electric Co., Ltd., Osaka (JP)

(21) Appl. No.: 16/134,290

(22) Filed: Sep. 18, 2018

(30) Foreign Application Priority Data
Sep. 21, 2017 (JP) 2017-181347

(51) Int. Cl. H01M 10/04; H01M 2/08

(52) U.S. Cl. CPC H01M 10/049; H01M 10/045; H01M 2/08

(57) ABSTRACT

A method for manufacturing a secondary battery includes welding a first negative-electrode current collector and a second negative-electrode current collector together by irradiation with an energy ray. The secondary battery includes an electrode assembly including a positive electrode plate and a negative electrode plate, a rectangular exterior body having an opening and containing the electrode assembly, a sealing plate that seals the opening in the rectangular exterior body, and a negative electrode terminal electrically connected to the negative electrode plate and attached to the sealing plate. The negative electrode plate is electrically connected to the negative electrode terminal by the first and second negative-electrode current collectors. At least one of the first and second negative-electrode current collectors is provided with a rough surface portion. The first and second negative-electrode current collectors are welded together by irradiating the rough surface portion with an energy ray.

### CROSS REFERENCE TO RELATED APPLICATIONS

The present invention application claims priority to Japanese Patent Application No. 2017-181347 filed in the Japan Patent Office on Sep. 21, 2017, the entire contents of which are incorporated herein by reference.

### BACKGROUND OF THE INVENTION

### Field of the Invention

The present disclosure relates to a method for manufacturing a secondary battery.

### Description of Related Art

Driving power sources of for example, electric vehicles (EVs) and hybrid electric vehicles (HEVs or PHEVs) include alkaline secondary batteries, nonaqueous electrolyte secondary batteries, etc., having a rectangular shape.

A rectangular secondary battery includes a battery case constituted by a rectangular exterior body having the shape of a tube with an opening and a bottom and a sealing plate that seals the opening. The battery case contains an electrode assembly, which includes positive electrode plates, negative electrode plates, and separators, together with an electrolyte. A positive electrode terminal and a negative electrode terminal are attached to the sealing plate. The positive electrode terminal is electrically connected to the positive electrode plates by a positive-electrode current collector, and the negative electrode terminal is electrically connected to the negative electrode plates by a negative-electrode current collector.

Each positive electrode plate includes a positive electrode core made of a metal and positive electrode active material mixture layers formed on the surfaces of the positive electrode core. The positive electrode core includes an exposed portion on which no positive electrode active material mixture layer is formed. The positive-electrode current collector is connected to the exposed portion of the positive electrode core. Each negative electrode plate includes a negative electrode core made of a metal and negative electrode active material mixture layers formed on the surface of the negative electrode core. The negative electrode core includes an exposed portion on which no negative electrode active material mixture layer is formed. The negative-electrode current collector is connected to the exposed portion of the negative electrode core.

For example, Japanese Published Unexamined Patent Application No. 2014-182993 (Patent Document 1) proposes a rectangular secondary battery including an electrode assembly in which exposed portions of positive and negative electrode cores are arranged at one end of the electrode assembly.

It is desirable to develop secondary batteries having a higher volume energy density for use in vehicles, in particular, EVs and PHEVs.

A rectangular secondary battery having a higher volume energy density can be easily manufactured when a current collecting member for electrically connecting the electrode assembly to a terminal is constituted by a plurality of current collectors. In such a case, the current collectors are desirably connected together with high reliability.

### BRIEF SUMMARY OF THE INVENTION

An object of the present invention is to provide a secondary battery with increased reliability.

A method for manufacturing a secondary battery according to an aspect of the present disclosure includes a welding step of welding a first current collector and a second current collector together by irradiation with an energy ray. The secondary battery includes an electrode assembly including a positive electrode plate and a negative electrode plate, an exterior body having an opening and containing the electrode assembly, a sealing plate that seals the opening, a terminal attached to the sealing plate, at least one tab portion that is provided on the positive electrode plate or the negative electrode plate, and the first current collector and the second current collector that electrically connect the tab portion to the terminal. At least one of the first current collector and the second current collector includes a rough surface portion having a surface roughness greater than surface roughnesses of other portions before the welding step. The first current collector and the second current collector are welded together by irradiating the rough surface portion with the energy ray in the welding step.

In the method for manufacturing the secondary battery according to the aspect of the present disclosure, the tab portion provided on the positive electrode plate or the negative electrode plate included in the electrode assembly is connected to the terminal by the first current collector and the second current collector. Accordingly, a secondary battery in which the space between the sealing plate and the electrode assembly is reduced to increase the energy density can be easily manufactured.

At least one of the first current collector and the second current collector includes the rough surface portion, and the first current collector and the second current collector are welded together by irradiating the rough surface portion with an energy ray. The rough surface portion has a surface roughness greater than those of other portions, and therefore does not reflect the energy ray as easily as other portions. Therefore, when the rough surface portion is irradiated with the energy ray, the temperature of the first current collector or the second current collector is easily increased, and the first current collector or the second current collector easily melts. Accordingly, the first current collector and the second current collector can be efficiently welded together, and the reliability of the welding connection portion can be increased. Furthermore, the occurrence of spattering and burr formation can be effectively reduced.

Therefore, a highly reliable secondary battery in which internal short-circuiting due to spattering or fallen burrs is reliably prevented can be obtained.

Preferably, the electrode assembly includes a first electrode assembly unit and a second electrode assembly unit and the at least one tab portion includes a plurality of tab portions, the first electrode assembly unit including a first tab group constituted by two or more of the tab portions, the second electrode assembly unit including a second tab group constituted by two or more of the tab portions, and the method further includes a tab-portion connecting step of connecting the first tab group and the second tab group to the second current collector; and a combining step of combining the first electrode assembly unit and the second electrode assembly unit together. The welding step is performed after the tab-portion connecting step, and the combining step is performed after the welding step.

With this method, a secondary battery having a higher volume energy density can be easily manufactured.

Preferably, the method further includes a fixing step of electrically connecting the first current collector to the terminal and fixing the first current collector to the sealing plate, the welding step being performed after the fixing step.

With this method, a secondary battery having a higher volume energy density can be easily manufactured.

Preferably, a projection provided on the first current collector is placed in an opening or a cut provided in the second current collector, and is welded to an edge portion around the opening or the cut in the welding step.

With this method, the first current collector and the second current collector can be more securely welded together, and the reliability of the secondary battery can be further increased.

The rough surface portion may be provided on the second current collector in a region around the opening or the cut.

The rough surface portion may be provided on the projection on the first current collector.

The rough surface portion may be formed on the at least one of the first current collector and the second current collector before the projection is placed in the opening or the cut.

With this method, even when fine metal powder is generated when the rough surface portion is formed, the metal powder can be easily removed from the first current collector or the second current collector. Since the secondary battery can be assembled after the metal powder is removed from the first current collector or the second current collector, the metal powder can be effectively prevented from entering the battery case.

The method may further include a rough-surface-portion forming step of forming the rough surface portion by irradiating the at least one of the first current collector and the second current collector with an energy ray after placing the projection in the opening or the cut, and the welding step may be performed after the rough-surface-portion forming step.

With this method, the rough surface portion can be reliably formed at a predetermined position. Therefore, the reliability of the welding connection portion can be increased.

The second current collector may include a thin portion that is thinner than other portions, and the rough surface portion may be formed on a surface of the thin portion. The thin portion is welded to the first current collector by irradiating the rough surface portion with the energy ray.

With this method, the first current collector and the second current collector can be more securely welded together, and the reliability of the secondary battery can be further increased.

Preferably, the rough surface portion is formed by irradiating the at least one of the first current collector and the second current collector with an energy ray.

With this method, a rough surface portion having a predetermined surface roughness can be reliably formed at a predetermined position.

The present disclosure provides a secondary battery with increased reliability.

### BRIEF DESCRIPTION OF THE SEVERAL VIEWS OF THE DRAWINGS

FIG. 1 is a perspective view of a rectangular secondary battery according to a first embodiment;

FIG. 2 is a sectional view taken along line II-II in FIG. 1;

FIG. 3 is a plan view of a positive electrode plate according to the first embodiment;

FIG. 4 is a plan view of a negative electrode plate according to the first embodiment;

FIG. 5 is a plan view of an electrode assembly unit according to the first embodiment:

FIG. 6 is a bottom view of a sealing plate to which components are attached;

FIG. 7 illustrates a step of connecting positive-electrode tab portions to a second positive-electrode current collector and negative-electrode tab portions to a second negative-electrode current collector;

FIG. 8A is a plan view of a first negative-electrode current collector;

FIG. 8B is a sectional view taken along line VIIIB-VIIIB in FIG. 8A;

FIG. 8C is an enlarged view of a current-collector projection illustrated in FIG. 8A;

FIG. 8D is an enlarged view of the current-collector projection illustrated in FIG. 8B;

FIG. 9A is a plan view of the second negative-electrode current collector;

FIG. 9B is a sectional view taken along line IXB-IXB in FIG. 9A;

FIG. 9C is an enlarged view of a current-collector opening illustrated in FIG. 9A;

FIG. 9D is an enlarged view of the current-collector opening illustrated in FIG. 9B:

FIG. 10 is an enlarged view of the region around a positive electrode terminal illustrated in FIG. 2;

FIG. 11 is an enlarged view of the region around a negative electrode terminal illustrated in FIG. 2;

FIGS. 12A and 12B are enlarged sectional views of the region around a connecting portion in which a first negative-electrode current collector and a second negative-electrode current collector are connected together in a secondary battery according to a second embodiment, where FIG. 12A illustrates the state before welding and FIG. 12B illustrates the state after welding;

FIGS. 13A and 13B are enlarged sectional views of the region around a connecting portion in which a first negative-electrode current collector and a second negative-electrode current collector are connected together in a secondary battery according to a third embodiment, where FIG. 13A illustrates the state before welding and FIG. 13B illustrates the state after welding;

FIG. 14 is an enlarged view of the region around a negative electrode terminal of a secondary battery according to a fourth embodiment; and

FIGS. 15A and 15B are enlarged sectional views of the region around a connecting portion in which a first negative-electrode current collector and a second negative-electrode current collector are connected together in the secondary battery according to the fourth embodiment, where FIG. 15A illustrates the state before welding and FIG. 15B illustrates the state after welding.

### DETAILED DESCRIPTION OF THE INVENTION

The structure of a rectangular secondary battery 20 according to a first embodiment will now be described. The present disclosure is not limited to the first embodiment.

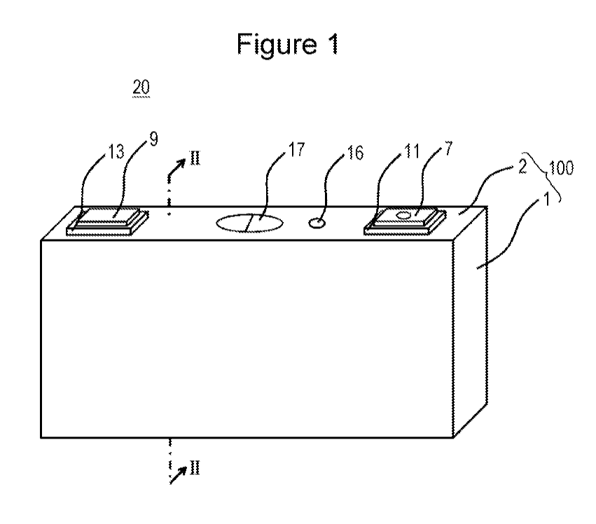

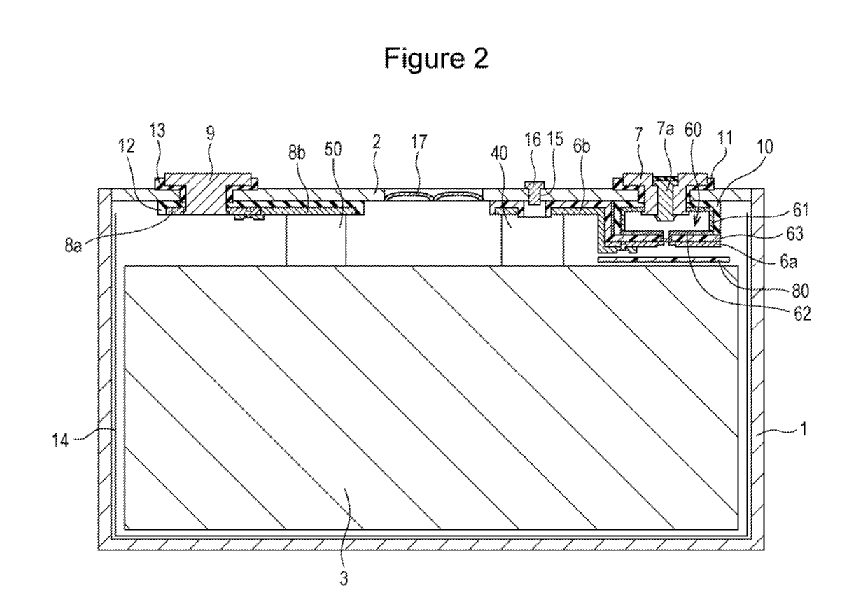

FIG. 1 is a perspective view of the rectangular secondary battery 20. FIG. 2 is a sectional view taken along line II-II in FIG. 1. As illustrated in FIGS. 1 and 2, the rectangular secondary battery 20 includes a battery case 100 constituted by a rectangular exterior body 1 having the shape of a tube with an opening and a bottom and a sealing plate 2 that seals the opening in the rectangular exterior body 1. The rectangular exterior body 1 and the sealing plate 2 are each preferably made of a metal, for example, aluminum or an aluminum alloy. The rectangular exterior body 1 contains an electrode assembly 3, which includes positive electrode plates and negative electrode plates, together with an electrolyte. An insulating sheet 14 made of a resin is disposed between the electrode assembly 3 and the rectangular exterior body 1.

Positive-electrode tab portions 40 and negative-electrode tab portions 50 are provided at an end of the electrode assembly 3 that is adjacent to the sealing plate 2. The positive-electrode tab portions 40 are electrically connected to a positive electrode terminal 7 via a first positive-electrode current collector 6a and a second positive-electrode current collector 6b. The negative-electrode tab portions 50 are electrically connected to a negative electrode terminal 9 via a first negative-electrode current collector 8a and a second negative-electrode current collector 8b.

The second positive-electrode current collector 6b extends parallel to the sealing plate 2, and the positive-electrode tab portions 40 are connected to a surface of the second positive-electrode current collector 6b that faces the electrode assembly 3. The positive-electrode tab portions 40 are in a bent state. Thus, the space between the sealing plate 2 and the electrode assembly 3 can be reduced, and the volume energy density of the secondary battery can be increased. The second negative-electrode current collector 8b extends parallel to the sealing plate 2, and the negative-electrode tab portions 50 are connected to a surface of the second negative-electrode current collector 8b that faces the electrode assembly 3. The negative-electrode tab portions 50 are in a bent state. Thus, the space between the sealing plate 2 and the electrode assembly 3 can be reduced, and the volume energy density of the secondary battery can be increased.

The positive electrode terminal 7 is fixed to the sealing plate 2 with an outer insulating member 11 made of a resin interposed therebetween. The negative electrode terminal 9 is fixed to the sealing plate 2 with an outer insulating member 13 made of a resin interposed therebetween. The positive electrode terminal 7 is preferably made of a metal, more preferably aluminum or an aluminum alloy. The negative electrode terminal 9 is preferably made of a metal, more preferably copper or a copper alloy. Still more preferably, the negative electrode terminal 9 includes a portion made of copper or a copper alloy disposed in the battery case 100 and a portion made of aluminum or an aluminum alloy disposed outside the battery case 100. The surface of the negative electrode terminal 9 is preferably plated with nickel.

A conductive path between the positive electrode terminal 7 and the positive electrode plates is provided with a current interruption mechanism 60 that is activated to break the conductive path between the positive electrode terminal 7 and the positive electrode plates when a pressure in the battery case 100 reaches or exceeds a predetermined pressure. A cover 80 made of a resin is disposed between the current interruption mechanism 60 and the electrode assembly 3. A conductive path between the negative electrode terminal 9 and the negative electrode plates may also be provided with a current interruption mechanism.

The sealing plate 2 is provided with a gas discharge valve 17 that breaks to enable gas in the battery case 100 to be discharged out of the battery case 100 when the pressure in the battery case 100 reaches or exceeds a predetermined pressure. The activating pressure of the gas discharge valve 17 is set to a pressure higher than the activating pressure of the current interruption mechanism 60.

The sealing plate 2 has an electrolyte introduction hole 15. The electrolyte introduction hole 15 is sealed by a sealing plug 16 after the electrolyte is introduced into the battery case 100 through the electrolyte introduction hole 15.

A method for manufacturing the rectangular secondary battery 20 will now be described.

### Production of Positive Electrode Plate

A positive electrode slurry containing a lithium nickel cobalt manganese composite oxide as a positive electrode active material, polyvinylidene fluoride (PVdF) as a binder, a carbon material as a conductive agent, and N-methyl-2-pyrrolidone (NMP) as a dispersion medium is prepared. The positive electrode slurry is applied to both sides of a rectangular piece of aluminum foil having a thickness of 15 μm that serves as a positive electrode core. Then, the positive electrode slurry is dried to remove N-methyl-2-pyrrolidone contained therein so that positive electrode active material mixture layers are formed on the positive electrode core. After that, a compression process is performed so that the thickness of the positive electrode active material mixture layers is reduced to a predetermined thickness. The thus-obtained positive electrode plate is cut into a predetermined shape.

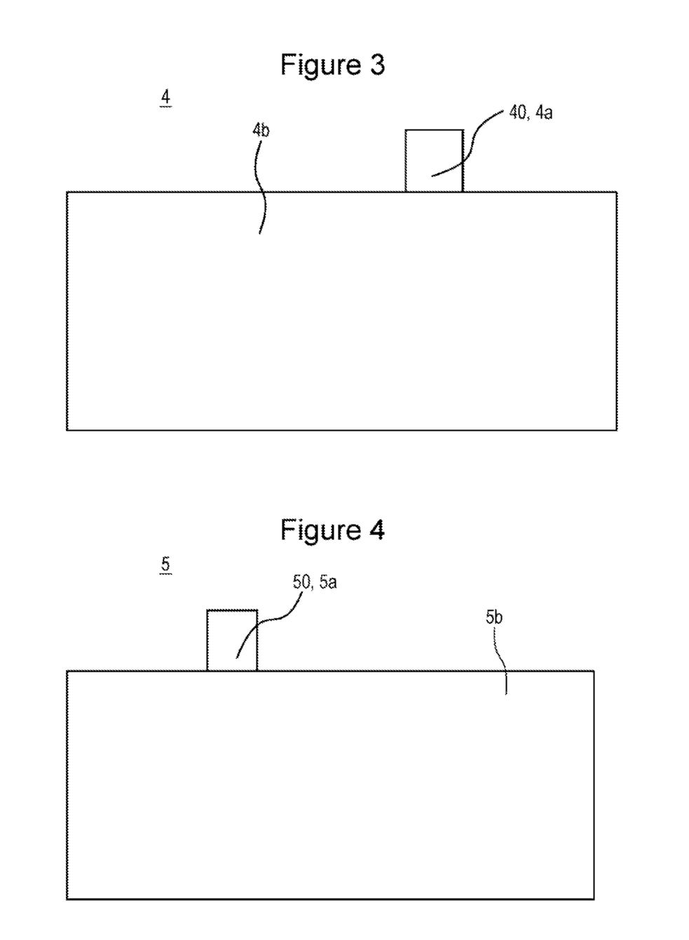

FIG. 3 is a plan view of a positive electrode plate 4 produced by the above-described method. As illustrated in FIG. 3, the positive electrode plate 4 includes a main portion in which positive electrode active material mixture layers 4b are formed on both sides of a positive electrode core 4a. The positive electrode plate 4 also includes a positive-electrode tab portion 40. The positive electrode core 4a projects from an edge of the main portion, and the projecting portion of the positive electrode core 4a constitutes the positive-electrode tab portion 40. The positive-electrode tab portion 40 may either be a portion of the positive electrode core 4a, as illustrated in FIG. 3, or be constituted by another member that is connected to the positive electrode core 4a. A positive-electrode protecting layer having an electrical resistance greater than that of the positive electrode active material mixture layers 4b may be provided on the positive-electrode tab portion 40 in regions adjacent to the positive electrode active material mixture layers 4b. The positive-electrode protecting layer preferably contains ceramic particles, such as alumnina, silica, or zirconia particles, and a binder. More preferably, the positive-electrode protecting layer contains conductive particles, such as particles of a carbon material.

### Production of Negative Electrode Plate

A negative electrode slurry containing graphite as a negative electrode active material, styrene-butadiene rubber (SBR) as a binder, carboxymethyl cellulose (CMC) as a thickener, and water is prepared. The negative electrode slurry is applied to both sides of a rectangular piece of copper foil having a thickness of 8 pun that serves as a negative electrode core. Then, the negative electrode slurry is dried to remove water contained therein so that negative electrode active material mixture layers are formed on the negative electrode core. After that, a compression process is performed so that the thickness of the negative electrode active material mixture layers is reduced to a predetermined thickness. The thus-obtained negative electrode plate is cut into a predetermined shape.

FIG. 4 is a plan view of a negative electrode plate 5 produced by the above-described method. As illustrated in FIG. 4, the negative electrode plate 5 includes a main portion in which negative electrode active material mixture layers 5b are formed on both sides of a negative electrode core 5a. The negative electrode plate 5 also includes a negative-electrode tab portion 50. The negative electrode core 5a projects from an edge of the main portion, and the projecting portion of the negative electrode core 5a constitutes the negative-electrode tab portion 50. The negative-electrode tab portion 50 may either be a portion of the negative electrode core 5a, as illustrated in FIG. 4, or be constituted by another member that is connected to the negative electrode core 5a.

### Production of Electrode Assembly Unit

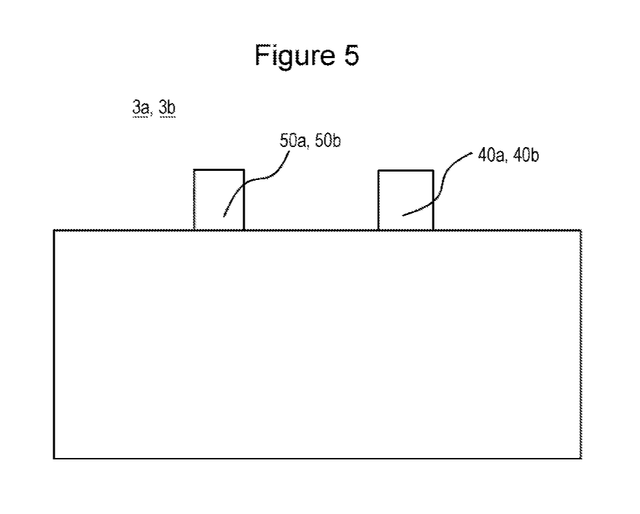

Electrode assembly units (3a and 3b) having a stacked structure are each produced by preparing 50 positive electrode plates 4 and 51 negative electrode plates 5 produced by the above-described method and stacking them together with rectangular separators made of polyolefin interposed therebetween. As illustrated in FIG. 5, each electrode assembly unit (first electrode assembly unit 3a, second electrode assembly unit 3b) has a positive-electrode tab group (first positive-electrode tab group 40a, second positive-electrode tab group 40b) including a stack of a plurality of positive-electrode tab portions 40 that are stacked together and a negative-electrode tab group (first negative-electrode tab group 50a, second negative-electrode tab group 50b) including a plurality of negative-electrode tab portions 50 that are stacked together at one end thereof. Each electrode assembly unit (3a, 3b) has separators at the outer sides thereof, and the electrode plates and the separators may be fastened together in the stacked state with a piece of tape or the like. Alternatively, the separators may be provided with adhesive layers so that the separators are bonded to the positive electrode plates 4 and to the negative electrode plates 5.

The size of the separators in plan view is preferably greater than or equal to that of the negative electrode plates 5. The positive electrode plates 4 and the negative electrode plates 5 may be stacked together after each of the positive electrode plates 4 and the negative electrode plates 5 is placed between two separators and the two separators are locally thermally welded together at the periphery thereof. Each electrode assembly unit (3a, 3b) may instead be produced by using an elongate separator and stacking the positive electrode plates 4 and the negative electrode plates 5 while fan-folding the elongate separator, or by using an elongate separator and stacking the positive electrode plates 4 and the negative electrode plates 5 while winding the elongate separator therearound. The electrode assembly units are not limited to those having a stacked structure, and may instead have a wound structure in which an elongate positive electrode plate and an elongate negative electrode plate are wound with an elongate separator interposed therebetween.

### Assembly of Sealing Body

A method for attaching the positive electrode terminal 7 and the first positive-electrode current collector 6a to the sealing plate 2 and the structure of the current interruption mechanism 60 will now be described with reference to FIGS. 2, 6, and 10. The outer insulating member 11 is placed on the outer side of a positive-electrode-terminal attachment hole 2a in the sealing plate 2. An inner insulating member 10 and a cup-shaped conductive member 61 are placed on the inner side of the positive-electrode-terminal attachment hole 2a in the sealing plate 2. Next, the positive electrode terminal 7 is inserted through a through hole in the outer insulating member 11, the positive-electrode-terminal attachment hole 2a in the sealing plate 2, a through hole in the inner insulating member 10, and a through hole in the conductive member 61. Then, an end portion of the positive electrode terminal 7 is crimped onto the conductive member 61. Thus, the positive electrode terminal 7, the outer insulating member 11, the sealing plate 2, the inner insulating member 10, and the conductive member 61 are fixed together. The crimped portion of the positive electrode terminal 7 is preferably welded to the conductive member 61 by, for example, laser welding. The inner insulating member 10 and the outer insulating member 11 are each preferably made of a resin.

The conductive member 61 has an opening at the end thereof adjacent to the electrode assembly 3. A disc-shaped deformation plate 62 is placed to cover the opening of the conductive member 61, and is welded to the conductive member 61 at the peripheral edge thereof. Thus, the opening of the conductive member 61 is sealed by the deformation plate 62. The conductive member 61 and the deformation plate 62 are each preferably made of a metal, more preferably aluminum or an aluminum alloy. The shape of the opening of the conductive member 61 at the end adjacent to the electrode assembly 3 is not limited to a circular shape, and may instead be a rectangular shape. The deformation plate 62 may have any shape as long as the opening of the conductive member 61 can be sealed by the deformation plate 62.

Next, a first insulating member 63 made of a resin is placed on a surface of the deformation plate 62 that faces the electrode assembly 3. Preferably, the first insulating member 63 has a connecting portion, and this connecting portion is connected to the inner insulating member 10. Preferably, the first insulating member 63 has a hook-shaped engagement portion, and the conductive member 61 has a flange, a recess, or a projection. The engagement portion of the first insulating member 63 is fixed to the flange, the recess, or the projection of the conductive member 61.

Fixing projections are formed on a surface of the first insulating member 63 that faces the electrode assembly 3. Preferably, the first insulating member 63 includes an insulating-member first region 63x disposed below the deformation plate 62, an insulating-member second region 63y that extends from an end of the insulating-member first region 63x toward the sealing plate 2, and an insulating-member third region 63z that extends horizontally from an end of the insulating-member second region 63y. The insulating-member third region 63z has an insulating-member opening 63a positioned to face the electrolyte introduction hole 15 in the sealing plate 2. An insulating-member projection 63b that projects toward the electrode assembly 3 is provided along the edge of the insulating-member opening 63a.

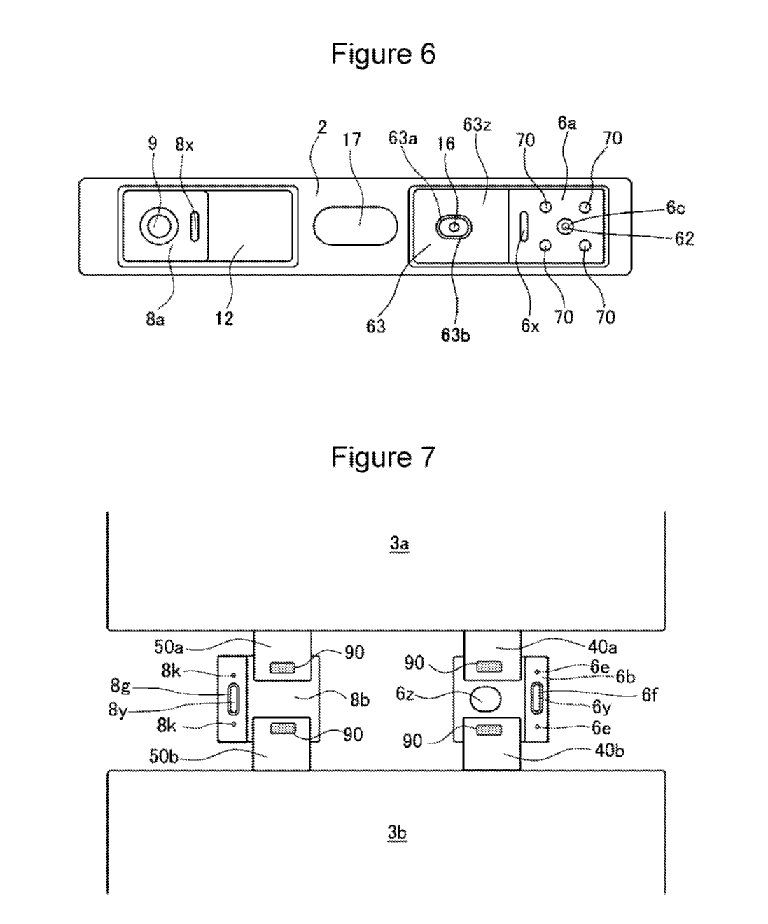

Next, the first positive-electrode current collector 6a is placed on the surface of the first insulating member 63 that faces the electrode assembly 3. The first positive-electrode current collector 6a has fixing through holes. The fixing projections on the first insulating member 63 are inserted through the fixing through holes in the first positive-electrode current collector 6a, and end portions of the fixing projections are radially expanded so that the first insulating member 63 and the first positive-electrode current collector 6a are fixed to each other. Thus, fixing portions 70 are formed. As illustrated in FIG. 6, the fixing portions 70 are preferably arranged so as to surround the connecting portion between the deformation plate 62 and the first positive-electrode current collector 6a. The number of fixing portions 70 is preferably two or more, more preferably three or more, still more preferably four or more.

After that, the deformation plate 62 and the first positive-electrode current collector 6a are welded together in a through hole formed in the first insulating member 63. Preferably, the first positive-electrode current collector 6a has a thin portion 6c, and the thin portion 6c is welded to the deformation plate 62. Preferably, the thin portion 6c has an opening 6d at the center thereof and is welded to the deformation plate 62 along the edge of the opening 6d. More preferably, the thin portion 6c has an annular notch that surrounds the connecting portion between the deformation plate 62 and the first positive-electrode current collector 6a. The first insulating member 63 and the first positive-electrode current collector 6a may be connected together in advance, and the first insulating member 63 to which the first positive-electrode current collector 6a is connected may be placed on the surface of the deformation plate 62 that faces the electrode assembly 3.

When the pressure in the battery case 100 reaches or exceeds a predetermined pressure, the deformation plate 62 is deformed such that a central portion thereof moves upward (toward the positive electrode terminal 7). The thin portion 6c of the first positive-electrode current collector 6a breaks as a result of the deformation of the deformation plate 62. Thus, the conductive path between the positive electrode terminal 7 and the positive electrode plates 4 is disconnected.

A terminal through hole 7b may be formed in the positive electrode terminal 7, and the deformation plate 62 and the first positive-electrode current collector 6a may be welded together while the deformation plate 62 is pressed against the first positive-electrode current collector 6a by introducing gas into the current interruption mechanism 60 through the terminal through hole 7b. The terminal through hole 7b is sealed by a terminal sealing member 7a. The terminal sealing member 7a preferably includes a metal plate 7x and a rubber member 7y.

A method for attaching the negative electrode terminal 9 and the first negative-electrode current collector 8a to the sealing plate 2 will now be described with reference to FIGS. 2, 6, and 11. The outer insulating member 13 is placed on the outer side of a negative-electrode-terminal attachment hole 2b in the sealing plate 2. An inner insulating member 12 and the first negative-electrode current collector 8a are placed on the inner side of the negative-electrode-terminal attachment hole 2b in the sealing plate 2. Next, the negative electrode terminal 9 is inserted through a through hole in the outer insulating member 13, the negative-electrode-terminal attachment hole 2b in the sealing plate 2, a through hole in the inner insulating member 12, and a through hole in the first negative-electrode current collector 8a. Then, an end portion of the negative electrode terminal 9 is crimped onto the first negative-electrode current collector 8a. Thus, the outer insulating member 13, the sealing plate 2, the inner insulating member 12, and the first negative-electrode current collector 8a are fixed together. The crimped portion of the negative electrode terminal 9 is preferably welded to the first negative-electrode current collector 8a by, for example, laser welding. The inner insulating member 12 and the outer insulating member 13 are each preferably made of a resin.

Connection between Second Current Collectors and Tab Portions

FIG. 7 illustrates a method for connecting the positive-electrode tab portions 40 to the second positive-electrode current collector 6b and a method for connecting the negative-electrode tab portions 50 to the second negative-electrode current collector 8b. Two electrode assembly units, which are a first electrode assembly unit 3a and a second electrode assembly unit 3b, are produced by the above-described method. The first electrode assembly unit 3a and the second electrode assembly unit 3b may have completely the same structure or different structures. The first electrode assembly unit 3a includes a first positive-electrode tab group 40a constituted by a plurality of positive-electrode tab portions 40 and a first negative-electrode tab group 50a constituted by a plurality of negative-electrode tab portions 50. The second electrode assembly unit 3b includes a second positive-electrode tab group 40b constituted by a plurality of positive-electrode tab portions 40 and a second negative-electrode tab group 50b constituted by a plurality of negative-electrode tab portions 50.

The second positive-electrode current collector 6b and the second negative-electrode current collector 8b are disposed between the first electrode assembly unit 3a and the second electrode assembly unit 3b. The first positive-electrode tab group 40a of the first electrode assembly unit 3a is placed on the second positive-electrode current collector 6b, and the first negative-electrode tab group 50a of the first electrode assembly unit 3a is placed on the second negative-electrode current collector 8b. The second positive-electrode tab group 40b of the second electrode assembly unit 3b is placed on the second positive-electrode current collector 6b, and the second negative-electrode tab group 50b of the second electrode assembly unit 3b is placed on the second negative-electrode current collector 8b. The first positive-electrode tab group 40a and the second positive-electrode tab group 40b are welded to the second positive-electrode current collector 6b so as to form welded portions 90. The first negative-electrode tab group 50a and the second negative-electrode tab group 50b are welded to the second negative-electrode current collector 8b so as to form welded portions 90. The welding method is preferably ultrasonic welding, resistance welding, or welding by irradiation with an energy ray, such as a laser beam. In particular, ultrasonic welding is preferred.

As illustrated in FIG. 7, the second positive-electrode current collector 6b has an opening 6z. The opening 6z is disposed at a position corresponding to the electrolyte introduction hole 15 in the sealing plate 2 after the second positive-electrode current collector 6b is connected to the first positive-electrode current collector 6a.

A fixing step of fixing the first positive-electrode current collector 6a and the first negative-electrode current collector 8a to the sealing plate 2 and a tab-portion-connecting step of connecting the positive-electrode tab portions 40 and the negative-electrode tab portions 50 to the second positive-electrode current collector 6b and the second negative-electrode current collector 8b, respectively, may be carried in either order. Preferably, the first positive-electrode current collector 6a and the second positive-electrode current collector 6b are connected together and the first negative-electrode current collector 8a and the second negative-electrode current collector 8b are connected together after the fixing step and the tab-portion-connecting step. In such a case, the volume energy density of the secondary battery can be increased.

### Connection Between First and Second Positive-Electrode Current Collectors

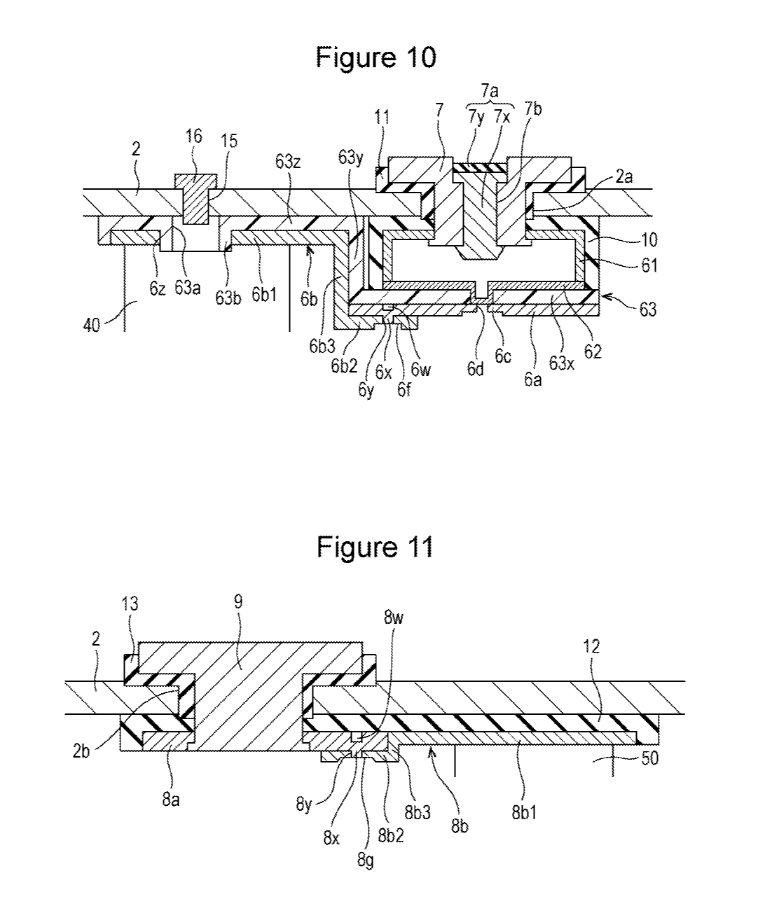

As illustrated in FIG. 6, the first positive-electrode current collector 6a has a current-collector projection 6x. As illustrated in FIG. 7, the second positive-electrode current collector 6b has a current-collector opening 6y. As illustrated in FIG. 10, the second positive-electrode current collector 6b is placed on the insulating-member third region 63z of the first insulating member 63 such that the current-collector projection 6x on the first positive-electrode current collector 6a is disposed in the current-collector opening 6y in the second positive-electrode current collector 6b. Then, the current-collector projection 6x on the first positive-electrode current collector 6a is welded to the edge of the current-collector opening 6y in the second positive-electrode current collector 6b by irradiation with an energy ray, such as a laser beam. Thus, the first positive-electrode current collector 6a and the second positive-electrode current collector 6b are connected together. The second positive-electrode current collector 6b has a first current-collector recess 6f in a region around the current-collector opening 6y. More specifically, the current-collector opening 6y is formed at the center of the first current-collector recess 6f. The first positive-electrode current collector 6a and the second positive-electrode current collector 6b are welded together in the first current-collector recess 6f. When the first current-collector recess 6f is formed in the region around the current-collector opening 6y, the first positive-electrode current collector 6a and the second positive-electrode current collector 6b can be welded together even when the current-collector projection 6x is not high.

As illustrated in FIG. 10, the second positive-electrode current collector 6b includes a tab-portion connection region 6b1 to which the positive-electrode tab portions 40 are connected and a current-collector connection region 6b2 to which the first positive-electrode current collector 6a is connected. The second positive-electrode current collector 6b also includes a connection region 6b3 that connects the tab-portion connection region 6b1 and the current-collector connection region 6b2. The distance between the sealing plate 2 and the tab-portion connection region 6b1 is smaller than the distance between the sealing plate 2 and the current-collector connection region 6b2 in the direction perpendicular to the sealing plate 2. According to this structure, the space occupied by the current collecting unit can be reduced, and the volume energy density of the secondary battery can be increased.

As illustrated in FIG. 7, the second positive-electrode current collector 6b has target holes 6e on both sides of the current-collector opening 6y. When the first positive-electrode current collector 6a and the second positive-electrode current collector 6b are welded together by irradiation with an energy ray, such as a laser beam, the target holes 6e are preferably used as image correction targets. Preferably, images of the target holes 6e are detected to perform position correction, and then the energy ray is applied along the outline of the current-collector opening 6y.

As illustrated in FIG. 10, the first positive-electrode current collector 6a has a second current-collector recess 6w in a surface thereof that faces the first insulating member 63 at a position behind the current-collector projection 6x. This is preferable because a larger welding connection portion can be easily formed between the first positive-electrode current collector 6a and the second positive-electrode current collector 6b. In addition, when the second current-collector recess 6w is formed, the risk that the first insulating member 63 will be damaged by heat generated in the welding process can be reduced when the first positive-electrode current collector 6a and the second positive-electrode current collector 6b are welded together.

As illustrated in FIG. 10, preferably, the bottom end (end adjacent to the electrode assembly 3) of the insulating-member projection 63b of the first insulating member 63 projects downward (toward the electrode assembly 3) beyond the bottom surface of the second positive-electrode current collector 6b around the opening 6z. In such a case, the sealing plug 16 can be reliably prevented from coming into contact with the second positive-electrode current collector 6b.

### Connection Between First and Second Negative-Electrode Current Collectors

As illustrated in FIG. 11, the first negative-electrode current collector 8a has a current-collector projection 8x. As illustrated in FIG. 7, the second negative-electrode current collector 8b has a current-collector opening 8y. As illustrated in FIG. 11, the second negative-electrode current collector 8b is placed on the inner insulating member 12 such that the current-collector projection 8x on the first negative-electrode current collector 8a is disposed in the current-collector opening 8y in the second negative-electrode current collector 8b. Then, the current-collector projection 8x on the first negative-electrode current collector 8a is welded to the edge of the current-collector opening 8y in the second negative-electrode current collector 8b by irradiation with an energy ray, such as a laser beam. Thus, the first negative-electrode current collector 8a and the second negative-electrode current collector 8b are connected together to form a welding connection portion. The second negative-electrode current collector 8b has a first current-collector recess 8g in a region around the current-collector opening 8y. More specifically, the current-collector opening 8y is formed at the center of the first current-collector recess 8g. The first negative-electrode current collector 8a and the second negative-electrode current collector 8b are welded together in the first current-collector recess 8g. Similar to the second positive-electrode current collector 6b, the second negative-electrode current collector 8b also has target holes 8k.

The first negative-electrode current collector 8a and the second negative-electrode current collector 8b are each preferably made of copper or a copper alloy.

As illustrated in FIG. 11, the first negative-electrode current collector 8a has a second current-collector recess 8w in a surface thereof that faces the inner insulating member 12 at a position behind the current-collector projection 8x. This is preferable because a larger welding connection portion can be easily formed between the first negative-electrode current collector 8a and the second negative-electrode current collector 8b. In addition, when the second current-collector recess 8w is formed, the risk that the inner insulating member 12 will be damaged by heat generated in the welding process can be reduced when the first negative-electrode current collector 8a and the second negative-electrode current collector 8b are welded together.

As illustrated in FIG. 11, the second negative-electrode current collector 8b includes a tab-portion connection region 8b1 to which the negative-electrode tab portions 50 are connected and a current-collector connection region 8b2 to which the first negative-electrode current collector 8a is connected. The second negative-electrode current collector 8b also includes a connection region 8b3 that connects the tab-portion connection region 8b1 and the current-collector connection region 862. The distance between the sealing plate 2 and the tab-portion connection region 8b1 is smaller than the distance between the sealing plate 2 and the current-collector connection region 8b2 in the direction perpendicular to the sealing plate 2. According to this structure, the space occupied by the current collecting unit can be reduced, and the volume energy density of the secondary battery can be increased. The first negative-electrode current collector 8a and the second negative-electrode current collector 8b are preferably arranged parallel to the sealing plate 2 with the inner insulating member 12 disposed between the sealing plate 2 and each of the first negative-electrode current collector 8a and the second negative-electrode current collector 8b. The inner insulating member 12 may be composed of a plurality of components.

The inner insulating member 12 preferably includes a fixing portion that is fixed to the second negative-electrode current collector 8b. In such a case, breakage or damage of the connecting portion between the first negative-electrode current collector 8a and the second negative-electrode current collector 8b due to impact, vibration, etc., can be reliably prevented. For example, a hook-shaped fixing portion may be formed on the inner insulating member 12, and the hook-shaped fixing portion on the inner insulating member 12 may be engaged with the second negative-electrode current collector 8b. Alternatively, a projection may be formed on the inner insulating member 12, and a fixing opening or cut may be formed in the second negative-electrode current collector 8b. The projection on the inner insulating member 12 may be inserted into the fixing opening or cut in the second negative-electrode current collector 8b and fixed by radially expanding an end portion thereof.

The shape of the current-collector projections 6x and 8x in plan view may be a perfect circular shape, but is preferably an oval or elliptical shape or a rectangular shape (which includes the shape of a rectangle with rounded corners).

### Production of Electrode Assembly

The first positive-electrode tab group 40a, the second positive-electrode tab group 40b, the first negative-electrode tab group 50a, and the second negative-electrode tab group 50b are bent so that the top surfaces of the first electrode assembly unit 3a and the second electrode assembly unit 3b illustrated in FIG. 7 are in contact with each other directly or with another component interposed therebetween. Thus, the first electrode assembly unit 3a and the second electrode assembly unit 3b are combined together to form a single electrode assembly 3.

The cover 80 is preferably disposed to face the first positive-electrode current collector 6a after the first positive-electrode current collector 6a and the second positive-electrode current collector 6b are connected together and before the first electrode assembly unit 3a and the second electrode assembly unit 3b are combined together. The cover 80 is preferably disposed to cover the welding connection portion between the first positive-electrode current collector 6a and the second positive-electrode current collector 6b. The cover 80 is preferably connected to the first insulating member 63. When the electrode assembly 3 is formed by combining the first electrode assembly unit 3a and the second electrode assembly unit 3b together, the cover 80 is disposed between the first positive-electrode current collector 6a, which is a component of the current interruption mechanism 60, and the electrode assembly 3.

### Assembly of Rectangular Secondary Battery

The electrode assembly 3 attached to the sealing plate 2 is covered with the insulating sheet 14, and is inserted into the rectangular exterior body 1. The insulating sheet 14 is preferably a flat sheet and is folded into a box shape or a bag shape. Then, the sealing plate 2 and the rectangular exterior body 1 are welded together by, for example, laser welding to seal the opening in the rectangular exterior body 1. After that, a nonaqueous electrolyte containing an electrolyte solvent and an electrolyte salt is introduced through the electrolyte introduction hole 15 in the sealing plate 2. Then, the electrolyte introduction hole 15 is sealed with the sealing plug 16.

### Connection Between First and Second Negative-Electrode Current Collectors

The structures of the first negative-electrode current collector 8a and the second negative-electrode current collector 8b and the method for connecting the first negative-electrode current collector 8a and the second negative-electrode current collector 8b together will now be described in detail.

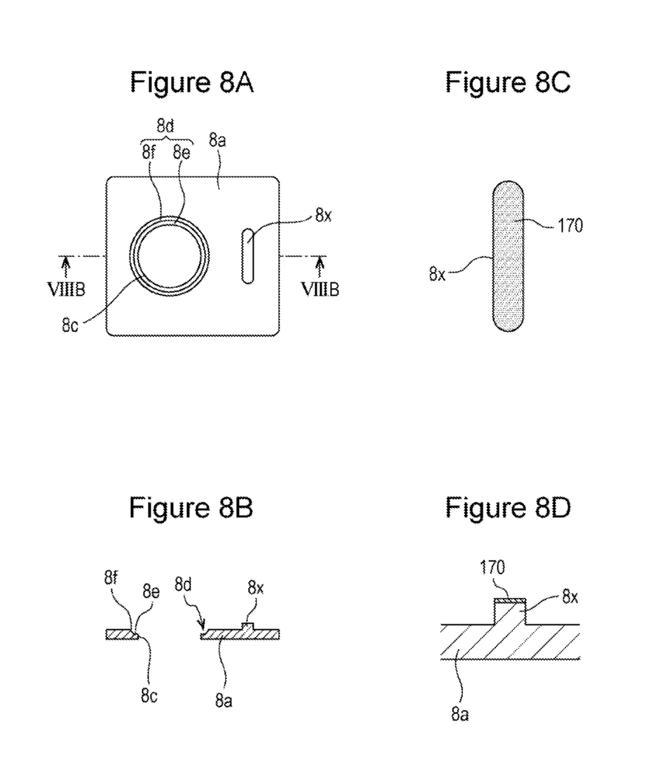

As illustrated in FIGS. 8A to 8D, the first negative-electrode current collector 8a has a terminal-receiving hole 8c. The negative electrode terminal 9 is inserted into the terminal-receiving hole 8c. A first current-collector recess 8d is formed around the terminal-receiving hole 8c. The first current-collector recess 8d includes a first horizontal portion 8e and a first inclined portion 8f. The first negative-electrode current collector 8a also has the current-collector projection 8x. The end surface of the current-collector projection 8x on the first negative-electrode current collector 8a has a rough surface portion 170. The rough surface portion 170 has a surface roughness greater than those of other portions of the first negative-electrode current collector 8a. The surface roughness of the rough surface portion 170 is preferably such that, for example, the arithmetical mean height Sa of the surface is 0.2 μm or greater, more preferably 0.5 μm or greater.

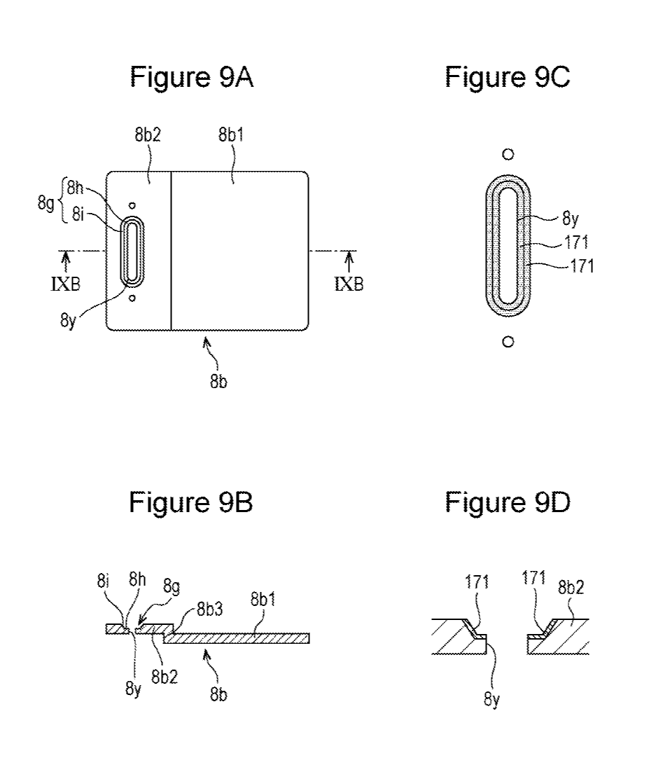

As illustrated in FIGS. 9A to 9D, the second negative-electrode current collector 8b has the current-collector opening 8y. The first current-collector recess 8g is formed around the current-collector opening 8y. The first current-collector recess 8g includes a second horizontal portion 8h and a second inclined portion 8i. The second horizontal portion 8h and the second inclined portion 8i in the region around the current-collector opening 8y include a rough surface portion 171. The rough surface portion 171 has a surface roughness greater than those of other portions of the second negative-electrode current collector 8b. The surface roughness of the rough surface portion 171 is preferably such that, for example, the arithmetical mean height Sa of the surface is 0.2 μm or greater, more preferably 0.5 μm or greater.

The first negative-electrode current collector 8a and the second negative-electrode current collector 8b that are structured as described above are used to manufacture the rectangular secondary battery 20 by the above-described method. The current-collector projection 8x on the first negative-electrode current collector 8a is disposed in the current-collector opening 8y in the second negative-electrode current collector 8b, and the engagement portion between the current-collector projection 8x and the current-collector opening 8y is irradiated with an energy ray, such as a laser beam, so that the first negative-electrode current collector 8a and the second negative-electrode current collector 8b are welded together. At this time, the rough surface portion 170 of the first negative-electrode current collector 8a and the rough surface portion 171 of the second negative-electrode current collector 8b are irradiated with the energy ray.

The rough surface portions 170 and 171 have surface roughnesses greater than those of other portions, and therefore do not easily reflect the energy ray. Therefore, when the rough surface portions 170 and 171 are irradiated with the energy ray, the temperatures of the first negative-electrode current collector 8a and the second negative-electrode current collector 8b are easily increased, and the first negative-electrode current collector 8a and the second negative-electrode current collector 8b easily melt. Accordingly, the first negative-electrode current collector 8a and the second negative-electrode current collector 8b can be efficiently welded together, and the reliability of the welding connection portion can be increased. Furthermore, the occurrence of spattering and burr formation can be effectively reduced. Therefore, a highly reliable secondary battery in which internal short-circuiting due to spattering or fallen burrs is reliably prevented can be obtained. When the first negative-electrode current collector 8a and the second negative-electrode current collector 8b are made of copper or a copper alloy, they have high melting points and easily reflect an energy ray. Therefore, it is particularly effective to form the rough surface portions and perform welding by irradiating the rough surface portions with the energy ray.

It is not necessary that the first negative-electrode current collector 8a and the second negative-electrode current collector 8b both have rough surface portions as long as at least one of the first negative-electrode current collector 8a and the second negative-electrode current collector 8b has a rough surface portion. When the second negative-electrode current collector 8b has a rough surface portion, the rough surface portion is preferably provided around the current-collector opening 8y. It is not necessary that the second negative-electrode current collector 8b have the first current-collector recess 8g. When the first current-collector recess 8g includes the second horizontal portion 8h and the second inclined portion Si, the rough surface portion may be provided only on the second horizontal portion 8h.

When the first negative-electrode current collector 8a has a rough surface portion, the rough surface portion is preferably provided on the end surface of the current-collector projection 8x. The surface roughness of the end surface of the current-collector projection 8x is preferably greater than the surface roughness of the side surface of the current-collector projection 8x. When the side surface of the current-collector projection 8x is not rough, the current-collector projection 8x can be inserted into the current-collector opening 8y without generating metal powder when the current-collector projection 8x comes into contact with the inner surface of the current-collector opening 8y.

Although the second negative-electrode current collector 8b has the current-collector opening 8y in the above-described example, a cut may be formed instead of the current-collector opening 8y. In such a case, the first negative-electrode current collector 8a and the second negative-electrode current collector 8b are welded together while the current-collector projection 8x is disposed in the cut.

The rough surface portion is preferably formed on at least one of the first negative-electrode current collector 8a and the second negative-electrode current collector 8b by irradiating at least one of the first negative-electrode current collector 8a and the second negative-electrode current collector 8b with an energy my. In this case, the rough surface portion can be reliably formed over a predetermined region. For example, the rough surface portion may be formed by using a laser marker. The laser may be a green laser having a wavelength of 532 rm.

Examples of methods for forming a rough surface portion other than the irradiation with the energy ray include methods using an abrasive or sandpaper, abrasive blasting, and chemical etching.

The timing at which the rough surface portion is formed on at least one of the first negative-electrode current collector Sa and the second negative-electrode current collector 8b is not particularly limited.

### Second Embodiment

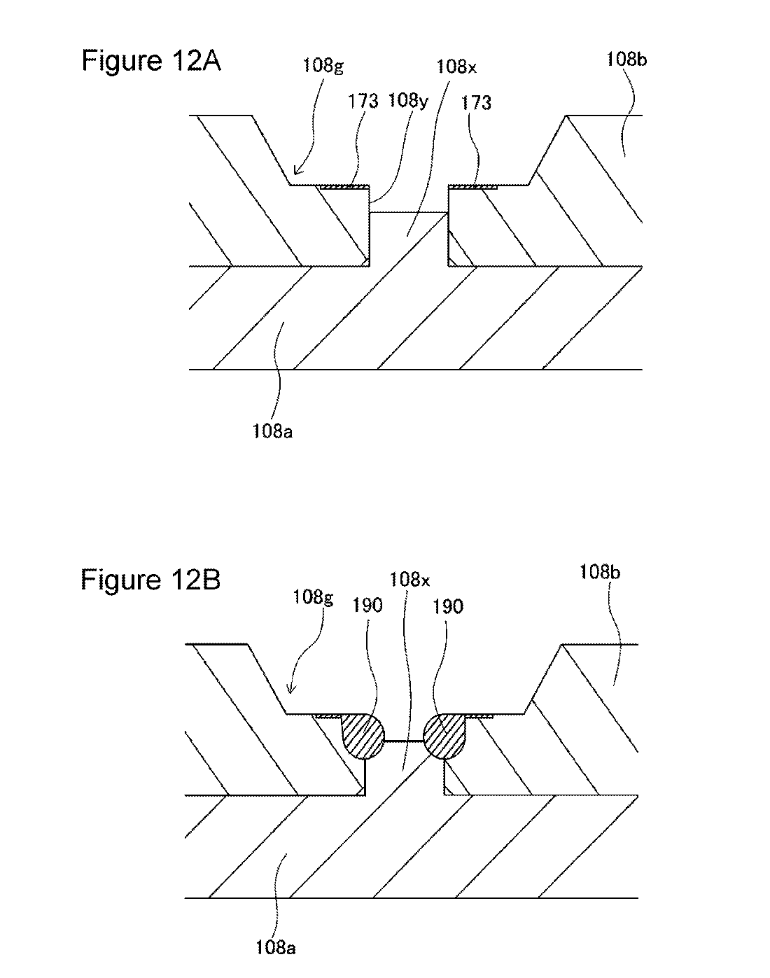

The structure of a rectangular secondary battery according to a second embodiment is the same as that of the above-described rectangular secondary battery 20 according to the first embodiment except for the structure around the current-collector projection on the first negative-electrode current collector and the structure around the current-collector opening in the second negative-electrode current collector. FIG. 12A is an enlarged sectional view of the region around a connecting portion between a first negative-electrode current collector 108a and a second negative-electrode current collector 108b, illustrating the state before welding. FIG. 12B is an enlarged sectional view of the region around the connecting portion between the first negative-electrode current collector 108a and the second negative-electrode current collector 108b, illustrating the state after welding.

As illustrated in FIG. 12A, the first negative-electrode current collector 108a has a current-collector projection 108x. The second negative-electrode current collector 108b has a current-collector opening 108y. The current-collector projection 108x is disposed in the current-collector opening 108y. A rough surface portion 173 is formed on the second negative-electrode current collector 108b in the region around the current-collector opening 108y. A first current-collector recess 108g is provided around the current-collector opening 108y, and the rough surface portion 173 is disposed in the first current-collector recess 108g.

The height of the current-collector projection 108x on the first negative-electrode current collector 108a is less than the height (depth) of the current-collector opening 108y in the second negative-electrode current collector 108b. Therefore, the end surface of the current-collector projection 108x is disposed in the current-collector opening 108y. According to this structure, even when the height (depth) of the current-collector opening 108y in the second negative-electrode current collector 108b or the height of the current-collector projection 108x on the first negative-electrode current collector 108a varies, the magnitude relationship between the height of the current-collector projection 108x on the first negative-electrode current collector 108a and the height (depth) of the current-collector opening 108y in the second negative-electrode current collector 108b can be effectively prevented from being reversed. Accordingly, the welding process can be more reliably performed, and the reliability of the welding connection portion can be further increased. The difference between the height of the current-collector projection 108x on the first negative-electrode current collector 108a and the height (depth) of the current-collector opening 108y in the second negative-electrode current collector 108b is preferably 1 mm or less, more preferably 0.5 mm or less, and still more preferably 0.2 mm or less. In addition, the difference is preferably 0.05 mm or greater. However, the difference is not limited to this.

The engagement portion between the current-collector projection 108x on the first negative-electrode current collector 108a and the current-collector opening 108y in the second negative-electrode current collector 108b is irradiated with an energy ray, such as a laser beam, so that a welding connection portion 190 is formed as illustrated in FIG. 12B.

The energy ray is controlled so that the rough surface portion 173 provided around the current-collector opening 108y receives a large portion thereof and that a portion of the second negative-electrode current collector 108b at the edge of the current-collector opening 108y melts more than the current-collector projection 108x on the first negative-electrode current collector 108a. Accordingly, the welding process can be more reliably performed. The rough surface portion may also be provided on the end surface of the current-collector projection 108x.

### Third Embodiment

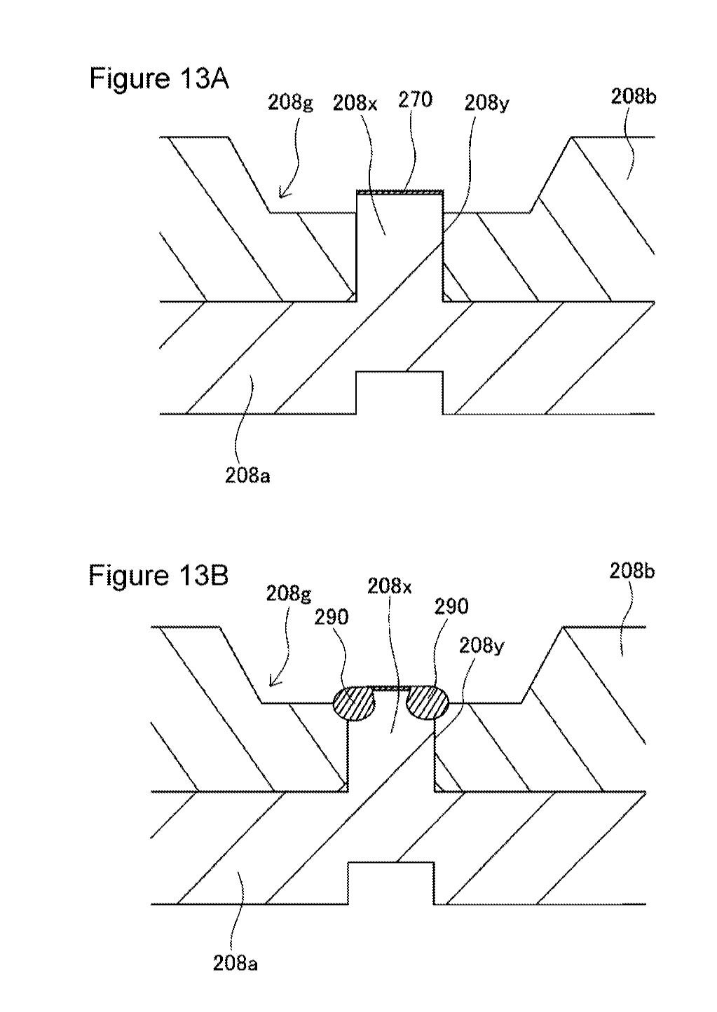

The structure of a rectangular secondary battery according to a third embodiment is the same as that of the above-described rectangular secondary battery 20 according to the first embodiment except for the structure around the current-collector projection on the first negative-electrode current collector and the structure around the current-collector opening in the second negative-electrode current collector. FIG. 13A is an enlarged sectional view of the region around a connecting portion between a first negative-electrode current collector 208a and a second negative-electrode current collector 208b, illustrating the state before welding. FIG. 13B is an enlarged sectional view of the region around the connecting portion between the first negative-electrode current collector 208a and the second negative-electrode current collector 208b, illustrating the state after welding.

As illustrated in FIG. 13A, the first negative-electrode current collector 208a has a current-collector projection 208x. The second negative-electrode current collector 208b has a current-collector opening 208y. The current-collector projection 208x is disposed in the current-collector opening 208y. A rough surface portion 270 is formed on the end surface of the current-collector projection 208x on the first negative-electrode current collector 208a. A first current-collector recess 208g is provided around the current-collector opening 208y.

The height of the current-collector projection 208x on the first negative-electrode current collector 208a is greater than the height (depth) of the current-collector opening 208y in the second negative-electrode current collector 208b. Therefore, the end surface of the current-collector projection 208x is disposed outside the current-collector opening 208y. According to this structure, even when the height (depth) of the current-collector opening 208y in the second negative-electrode current collector 208b or the height of the current-collector projection 208x on the first negative-electrode current collector 208a varies, the magnitude relationship between the height of the current-collector projection 208x on the first negative-electrode current collector 208a and the height (depth) of the current-collector opening 208y in the second negative-electrode current collector 208b can be effectively prevented from being reversed. Accordingly, the welding process can be more reliably performed, and the reliability of the welded portion can be further increased. The difference between the height of the current-collector projection 208x on the first negative-electrode current collector 208a and the height (depth) of the current-collector opening 208y in the second negative-electrode current collector 208b is preferably 1 mm or less, more preferably 0.5 mm or less, and still more preferably 0.2 mm or less. In addition, the difference is preferably 0.05 mm or greater. However, the difference is not limited to this.

The engagement portion between the current-collector projection 208x on the first negative-electrode current collector 208a and the current-collector opening 208y in the second negative-electrode current collector 208b is irradiated with an energy ray, such as a laser beam, so that a welding connection portion 290 is formed as illustrated in FIG. 13B.

The energy ray is controlled so that the rough surface portion 270 provided on the current-collector projection 208x on the first negative-electrode current collector 208a receives a large portion thereof and that the current-collector projection 208x on the first negative-electrode current collector 208a melts more than the second negative-electrode current collector 208b.

Accordingly, the welding process can be more reliably performed. The rough surface portion may also be provided on the second negative-electrode current collector 208b in the region around the current-collector opening 208y.

### Fourth Embodiment

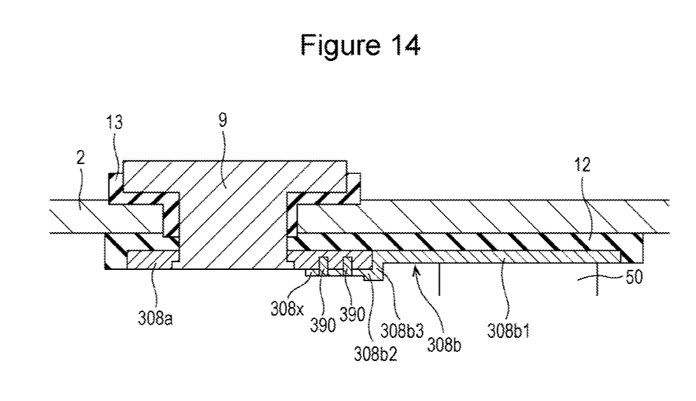

The structure of a rectangular secondary battery according to a fourth embodiment is the same as that of the above-described rectangular secondary battery 20 according to the first embodiment except for the structure around the current-collector projection on the first negative-electrode current collector and the structure around the current-collector opening in the second negative-electrode current collector. FIG. 14 is a sectional view of the region around a negative electrode terminal 9 of a rectangular secondary battery according to the fourth embodiment taken in the longitudinal direction of a sealing plate 2.

A second negative-electrode current collector 308b includes a tab-portion connection region 308b1 to which the negative-electrode tab portions 50 are connected and a current-collector connection region 308b2 to which a first negative-electrode current collector 308a is connected. The second negative-electrode current collector 308b also includes a connection region 308b3 that connects the tab-portion connection region 308b1 and the current-collector connection region 308b2.

The current-collector connection region 308b2 includes a thin portion 308x that is thinner than other portions. The thin portion 308x of the second negative-electrode current collector 308b is welded to the first negative-electrode current collector 308a, so that welding connection portions 390 are formed.

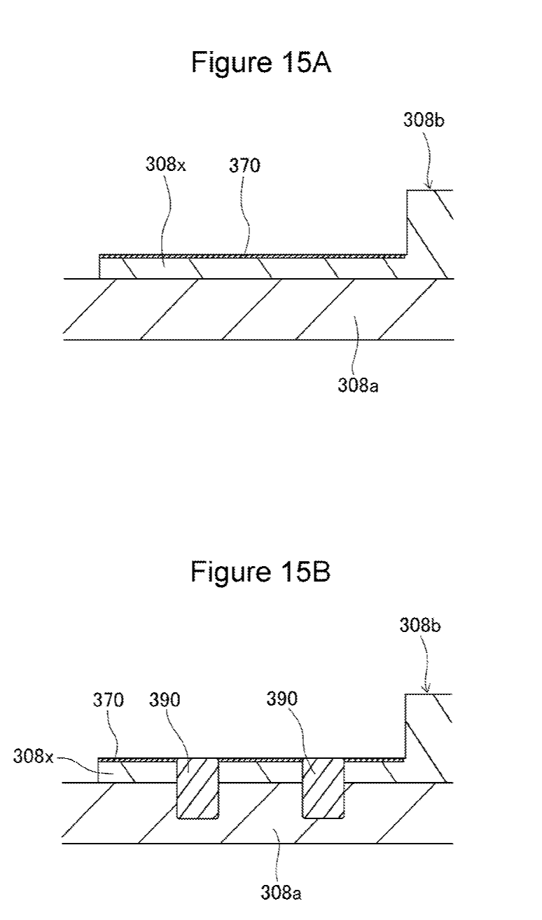

FIGS. 15A and 15B are enlarged sectional views of the region around the welding connection portions 390 between the first negative-electrode current collector 308a and the second negative-electrode current collector 308b in the secondary battery according to the fourth embodiment. FIG. 15A illustrates the state before welding, and FIG. 15B illustrates the state after welding.

As illustrated in FIG. 15A, a rough surface portion 370 is formed on the thin portion 308x of the second negative-electrode current collector 308b. The rough surface portion 370 is irradiated with an energy ray so that the welding connection portions 390 are formed as illustrated in FIG. 15B. Thus, the first negative-electrode current collector 308a and the second negative-electrode current collector 308b are welded together.

### Others

In the above-described first embodiment, the electrode assembly 3 is formed of two electrode assembly units. However, the electrode assembly 3 is not limited to this, and may instead be formed of a single stacked structure, or a single wound structure in which an elongate positive electrode plate and an elongate negative electrode plate are wound with an elongate separator interposed therebetween. Alternatively, the electrode assembly 3 may include three or more electrode assembly units. Each electrode assembly unit may have a wound structure or a stacked structure.

Preferably, the first and second positive-electrode current collectors are connected to each other and the first and second negative-electrode current collectors are connected to each other by irradiation with an energy ray, such as a laser beam, an electron beam, or an ion beam. The type of the energy ray is not particularly limited as long as the first and second negative-electrode current collectors can be welded together.

In the above-described first embodiment, the flange of the negative electrode terminal 9 is disposed outside the battery case 100, and the negative electrode terminal 9 is inserted into the terminal-receiving hole Sc in the first negative-electrode current collector 8a and crimped in the battery case 100. However, the flange of the negative electrode terminal 9 may instead be disposed in the battery case 100, and the negative electrode terminal 9 may be inserted into a terminal-receiving hole formed in a conductive member disposed outside the battery case 100 and be crimped outside the battery case 100. In such a case, the first negative-electrode current collector 8a is welded to the flange of the negative electrode terminal 9.

In the above-described first embodiment, the rough surface portion is provided on at least one of the first negative-electrode current collector 8a and the second negative-electrode current collector 8b. The rough surface portion may also be provided on at least one of the first positive-electrode current collector 6a and the second positive-electrode current collector 6b.

In the above-described first embodiment, the conductive path between the positive electrode terminal 7 and the positive electrode plates is provided with the current interruption mechanism 60. However, the current interruption mechanism 60 may be omitted. In the case where the current interruption mechanism 60 is not provided, the first and second positive-electrode current collectors may have the same shapes as those of the first and second negative-electrode current collectors, respectively.

While detailed embodiments have been used to illustrate the present invention, to those skilled in the art, however, it will be apparent from the foregoing disclosure that various changes and modifications can be made therein without departing from the spirit and scope of the invention. Furthermore, the foregoing description of the embodiments according to the present invention is provided for illustration only, and is not intended to limit the invention.

What is claimed is:

1. A method for manufacturing a secondary battery including an electrode assembly including a positive electrode plate and a negative electrode plate, an exterior body having an opening and containing the electrode assembly, a sealing plate that seals the opening, a terminal attached to the sealing plate, at least one tab portion that is provided on the positive electrode plate or the negative electrode plate, and a first current collector and a second current collector that electrically connect the tab portion to the terminal, the method comprising:
a welding step of welding the first current collector and the second current collector together by irradiation with an energy ray,
wherein at least one of the first current collector and the second current collector includes a rough surface portion having a surface roughness greater than surface roughnesses of other portions before the welding step, and
wherein the first current collector and the second current collector are welded together by irradiating the rough surface portion with the energy ray in the welding step.

2. The method according to claim 1, wherein the electrode assembly includes a first electrode assembly unit and a second electrode assembly unit and the at least one tab portion includes a plurality of tab portions, the first electrode assembly unit including a first tab group constituted by two or more of the tab portions, the second electrode assembly unit including a second tab group constituted by two or more of the tab portions, and
wherein the method further comprises:
a tab-portion connecting step of connecting the first tab group and the second tab group to the second current collector; and
a combining step of combining the first electrode assembly unit and the second electrode assembly unit together,
wherein the welding step is performed after the tab-portion connecting step, and
wherein the combining step is performed after the welding step.

3. The method according to claim 2, further comprising:
a fixing step of electrically connecting the first current collector to the terminal and fixing the first current collector to the sealing plate,
wherein the welding step is performed after the fixing step.

4. The method according to claim 1, wherein a projection provided on the first current collector is placed in an opening or a cut provided in the second current collector and is welded to an edge portion around the opening or the cut in the welding step.

5. The method according to claim 4, wherein the rough surface portion is provided on the second current collector in a region around the opening or the cut.

6. The method according to claim 4, wherein the rough surface portion is provided on the projection on the first current collector.

7. The method according to claim 4, wherein the rough surface portion is formed on the at least one of the first current collector and the second current collector before the projection is placed in the opening or the cut.

8. The method according to claim 4, further comprising:
a rough-surface-portion forming step of forming the rough surface portion by irradiating the at least one of the first current collector and the second current collector with an energy ray after placing the projection in the opening or the cut,
wherein the welding step is performed after the rough-surface-portion forming step.

9. The method according to claim 1, wherein the second current collector includes a thin portion that is thinner than other portions,
wherein the rough surface portion is formed on a surface of the thin portion, and
wherein the thin portion is welded to the first current collector by irradiating the rough surface portion with the energy ray.

10. The method according to claim 1, wherein the rough surface portion is formed by irradiating the at least one of the first current collector and the second current collector with an energy ray.
